(19) United States
(12) Patent Application Publication
(10) Pub. No.: US 2002/0032269 A1
(43) Pub. Date: Mar. 14, 2002

(54) Pigmented recording material

(75) Inventors: Volker Schobe, Willstatt (DE); Christoph Roth, Halle (DE); Angela Kuhrt, Wolfen (DE); Wilfried Weigt, Dessau (DE)

Correspondence Address: GREENBLUM & BERNSTEIN, P.L.C., 1941 ROLAND CLARKE PLACE, RESTON, VA, 20191, US

(73) Assignee: EMTEC MAGNETICS GmbH, Ludwigshafen (DE)

(21) Appl. No.: 09/850,299

(22) Filed: May 8, 2001

(30) Foreign Application Priority Data
May 9, 2000 (DE) 100 22 529.2

(51) Int. Cl. C08L 1/00; C08J 3/00; C08K 3/34; C08K 3/00; C08L 31/00; C08L 33/00

(52) U.S. Cl. 524/492; 524/556

(57) ABSTRACT

Water-resistant pigmented recording material which is useful for inkjet printers. The ink-receiving layer comprises silica dispersions modified with alkylsilanes, water-soluble plasticizers and polymeric ink fixatives. The material provides image recording in photo quality on conventional types of printers.

### CROSS-REFERENCE TO RELATED APPLICATIONS

The present application claims priority under 35 U.S.C. 119 of German Patent Application No. 100 22 529.2, filed May 9, 2000, the disclosure of which is expressly incorporated by reference herein in its entirety.

### BACKGROUND OF THE INVENTION

1. Field of the Invention

The present invention relates to water-resistant pigmented recording material. The pigmented recording material according to the present invention is particularly useful as inkjet paper for photo quality image recording in inkjet printers.

2. Discussion of Background Information

Image recording utilizing the inkjet process has come to be widely used in both private and commercial environments. Image quality, especially the reproduction of details, depends not only on the type of printer used but also on the properties of the recording material. Recording materials have to meet very high requirements, especially when paper is used as base material, to ensure simple handling and broad utility. The material preferably possesses:

high resolution and crispness

rapid drying

low tackiness

good wipe resistance of inks

high color density

high water resistance.

It is also desirable that the materials should be useful for most commercially available types of printers. Broad utility is ensured by materials which possess sufficient water resistance as well as good resolution and color reproduction. Numerous processes and materials have been described in order that these properties may be achieved. There are 3 principal routes:

1. Loading the ink-receiving layers with a high pigment content

2. Using water-insoluble polymers as binders

3. Crosslinking of water-soluble binders.

Pigments used for water-resistant pigment layers include not only organic pigments, such as disclosed in U.S. Pat. Nos. 5,989,088, 6,020,058, and DE 196 28 341, but also inorganic pigments. A useful inorganic pigment is silica, such as disclosed in WO 99/21703, WO 99/07558, and EP 0 879 709. Quite frequently there are also proposals of pigments based on aluminas/pseudoboehmite, such as disclosed in EP 0 636 489, EP 866 749, WO 97/22476, EP 0 891 873, EP 0 916 512, EP 0 967 086 and WO 97/15457.

Materials comprising water-resistant layers from water-insoluble polymers as binders can be prepared not only by coating with solvent-dissolved polymers, for example, polyvinyl acetals, such as disclosed in U.S. Pat. No. 5,985,424, DE 196 23 432, and JP 11-208104, but also by coating with polymeric dispersions, such as disclosed in DE 196 28 342, EP 0 965 459 and WO 99/04981.

It is further known to crosslink water-soluble binders to improve their water resistance. Gelatin has frequently been proposed as readily crosslinkable binder, useful crosslinkers being formaldehyde, polyepoxides, carbamoyl compounds, aziridines, triacryloyl formal or vinyl sulfone derivatives, such as disclosed in EP 0 869 010, EP 0 829 375 and EP 0 913 266.

DE 197 15 186 proposes epoxide-functional silica sols as crosslinkers for gelatinic inkjet materials. Boric acid has been described as a crosslinker when polyvinyl alcohol is used as a binder, such as disclosed in EP 0 888 904.

It is further known to use reactive groups in the binder layers and a subsequent treatment to initiate a crosslinking reaction which leads to the desired improvement in water resistance. Examples are a subsequent electron beam curing, such as disclosed in EP 0 919 395, or a thermally initiated free-radical crosslinking of monomers, such as disclosed in EP 0 916 512.

To fix the dye after the recording material has been printed, such materials usually additionally include mordants based on quaternary amines or polymers thereof. Examples are quaternary aminopolyacrylates, polyvinylpyridine, polyethyleneimine or guanidine derivatives, such as disclosed in EP 0 688 267.

It is also known to use, in the ink-receiving layer, reactive couplers capable of reacting with the binders in the ink in order that dye fixation may be realized, such as disclosed in EP 0 976 572.

All these known recording materials realize the present high requirements only to a limited extent. For instance, most water-resistant materials are suitable only for certain types of printers or are still excessively tacky in the printed areas.

To reduce tackiness, materials have been proposed with a multilayered construction which are said to be capable, in particular, of absorbing the solvents in the inks better. Examples of such materials are described in DE 196 18 607, EP 0 685 344, EP 0 887 201, WO 96/14634 and WO 97/15456.

### SUMMARY OF THE INVENTION

The present invention relates to providing an improved water-resistant recording material for, for example, inkjet printers, that comprises pigmented layers based on silica and that does not have the disadvantages of known materials. The new material provides high resolution, possesses low tackiness in the printed areas, and is suitable for most conventional types of printers.

The present invention relates to a pigmented recording material comprising an ink-receiving layer, wherein the ink-receiving layer includes the following constituents:

a) 5-25% by weight of polymeric ink-fixing mixture of water-soluble and water-insoluble cationic polymers;

b) 5-20% by weight of a water-soluble plasticizer; and

c) 30-80% by weight of silica dispersion obtained by surface modification with alkylsilanes of the structural formula R₁Si(OR₂)₃ wherein R₁ is vinyl, acryloyl, methacryloyl or C₁-C₈-alkyl, R₂ is methyl or ethyl, and said silica dispersion to said alkylsilane being in a weight ratio in a range from 1:1 to 9:1.

The ink-receiving layer can further include up to 20% by weight of a polymer dispersion having a glass transition temperature of <25° C.

The silica dispersion can have a particle size in a range from 0.04 to 0.3 μm.

The ink-receiving layer can include a mixture of silica dispersions having different particle sizes.

The ink-receiving layer can include a mixture of silica dispersions having different particle sizes.

The surface modification can be effected using an alkylsilane mixture.

The water-soluble plasticizer can be polyethylene glycol having an average molecular weight of from 200 to 20,000 daltons or mixtures thereof.

The polymer dispersion can include polyacrylates or butanediene-styrene copolymers.

A layer of at least one crosslinked water-soluble polymer 0.5-5 μm in thickness can be included as a protective layer for the ink-receiving layer.

The present invention also relates to a method of printing comprising printing onto the recording material using an inkjet printer, as well as a method forming the recording material.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description making apparent to those skilled in the art how the several forms of the present invention may be embodied in practice.

The present invention provides a recording material whose ink-receiving layer includes the following constituents in the ink-receiving layer:

a) 5-25% by weight of a polymeric ink-fixing mixture of water-soluble and water-insoluble polymers;

b) 5-20% by weight of a water-soluble plasticizer;

c) 0-20% by weight of a polymer dispersion having a glass transition temperature of <25° C.; and

d) 30-80% by weight of a silica dispersion obtained by surface modification with alkylsilanes of the structural formula R₁Si(OR₂)₃ wherein R₁ is vinyl, acryloyl, methacryloyl or C₁-C₈-alkyl, R₂ is methyl or ethyl and the weight ratio of silica dispersion to alkylsilane is in the range from 1:1 to 9:1.

The recording materials of the present invention can be prepared by doctor, slot or extrusion coating a coating solution, for example, using known techniques, onto (polyethylene) PE-coated paper which has been provided with an adhesive layer.

Preferred solvents for the coating solution are mixtures of water and alcohols. The wet cast thickness or coating rate is chosen so as to provide a dry layer thickness in the range from 12 to 30 μm. Depending on the length of the drying zone, the layer is dried at from 80 to 130° C. The weight percents of ingredients (a)-(d) do not include solvent.

Useful water-soluble polymeric ink fixatives include polymers of the composition:

| | |
|---|---|
| quaternary polyvinylpyridine | (polymer 1) |
| polymethacryloyloxyethyltrimethylammonium chloride | (polymer 2) |
| polydimethyldiallylammonium chloride | (polymer 3) |
| acrylic acid/methacryloyloxyethyltrimethylammonium | (polymer 4) |
| chloride | |
| acrylic acid/methacrylamidopropyltrimethylammonium | (polymer 5) |
| chloride | |
| acrylamide/methacrylamidopropyltrimethylammonium | (polymer 6) |
| chloride | |
| vinylpyrrolidone/methacrylamidopropyltrimethylammonium | (polymer 7) |
| chloride | |
| vinylpyrrolidone/methacryloyloxyethyltrimethylammonium | (polymer 8) |
| chloride | |

The water-insoluble polymeric ink fixatives can be used not only as solution in an organic solvent but also as an aqueous dispersion. Examples of such polymers are interpolymers of the composition:

| | |
|---|---|
| styrene/methacryloyloxyethyltrimethylammonium chloride | (polymer 9) |
| β-hydroxyethyl acrylate/methacryloyloxy- | (polymer 10) |
| ethyltrimethylammonium chloride | |
| Ethyl acrylate/methacryloyloxyethyltrimethylammonium | (polymer 11) |
| chloride | |
| styrene/β-hydroxyethyl acrylate/meth- | (polymer 12) |
| acryloyloxyethyltrimethylammonium chloride | |

The concentration of the polymeric ink fixatives in the layer is in the range from 5 to 25% by weight, preferably in the range from 15 to 22% by weight. The weight ratio of water-soluble to water-insoluble ink fixatives is not critical and can be in the range from 3:1 to 1:2.

Useful plasticizers for the ink-receiving layer include, in particular, water-soluble polyglycols or derivatives thereof which are plasticizers. To obtain a long-term effect and suppress cracking, preference is given to glycols of low volatility, for example tetraethylene glycols or higher glycols. Preference is given to a polyethylene glycol having an average molecular weight of from 200 to 20,000 daltons or mixtures thereof. It is also possible to use plasticizer mixtures as described, for example, in WO 97/15457, which is incorporated by reference herein in its entirety. The plasticizers are used in an amount of from 5 to 20% by weight.

In addition to the water-soluble plasticizers, the layer may additionally include from 0 to 20% by weight of a soft polymer dispersion having a glass transition temperature of <25° C., which helps to provide the layer with good elasticity. Useful polymer dispersions include, but are not limited to, for example, interpolymers based on butadiene and styrene or else polyacrylate dispersions.

The main component in the material of the invention is from 30 to 80% by weight of water-insoluble inorganic pigment based on silica which is surface modified by reaction with alkylsilanes of the structural formula R₁Si(OR₂)₃, where R₁ is vinyl, acryloyl, methacryloyl or C₁-C₈-alkyl and R₂ is methyl or ethyl. This modification ensures very good layer formation, low roughness, low cracking tendency and improved compatibility with the polymeric components. Preferred silanes for this surface modification are:

vinyltriethoxysilane

vinyltrimethoxysilane

methacryloyloxypropyltrimethoxysilane

methyltriethoxysilane

methyltrimethoxysilane

ethyltriethoxysilane

isobutyltriethoxysilane

It is also possible to use mixtures of these silanes for the surface modification. The weight ratio of silica to alkylsilane is in the range from 1:1 to 9:1, but preferably is in the range from 1:1 to 4:1.

Starting dispersions used are aqueous silica dispersions having a preferred particle size in the range from 0.04 to 0.3 μm, preferably from 0.1 to 0.2 μm.

The modification is effected by stirring and diluting the dispersion with alcohols and then admixing it with silanes. This is followed by the reaction at from 40 to 75° C. for from 3 to 15 hours.

It is preferably also possible to use pigment mixtures having different particle sizes.

The high pigment concentration usually provides matt layers. Additionally, therefore, to obtain a high gloss material, a protective layer of crosslinked polymers or other water-resistant binders may be applied in a thickness of from 0.5 to 5 μm. Gelatin is very useful for this purpose, and it is crosslinked with curing agents. Such a protective layer may further also include polymer dispersions and pigments as antiblocking agents.

The recording material of the invention is notable, in particular when used in inkjet printers, for good water resistance, good ink fixation and rapid drying. Tackiness is greatly reduced in the printed areas. The modification of the pigments provides an elastic and crack-free material which provides good color separation and reproduction in photo quality. No reduction in quality is observed even after long-term storage.

The invention is illustrated by the following Examples, which are provided for the purpose of representation, and are not to be construed as limiting the scope of the invention. Unless stated otherwise, all percentages, parts, etc., are by weight.

### EXAMPLES

### Example 1

(Preparation of Pigment 1)

In a heatable stirred vessel, 11.29 kg of an aqueous silica dispersion (15% strength, particle size 0.12 μm) are mixed with 36 g of phthalic anhydride and stirred until dissolved. This is followed by the addition of 5.64 kg of isopropanol, 1.3 kg of methyltriethoxysilane and 0.3 kg of methacryloyloxypropyltrimethoxy-silane. The mixture is heated to 70° C. with stirring and stirred for 8 hours. A stable pigment dispersion is obtained on cooling.

### Example 2

(Preparation of Pigment 2)

Example 1 is repeated except that the silica dispersion is reacted with 0.5 kg of vinyltriethoxysilane and 0.4 kg of methyltriethoxysilane.

### Example 3

(Preparation of Pigment 3)

Example 1 is repeated except that the silica dispersion is reacted with 1.2 kg of glycidoxypropyltrimethylsilane.

### Example 4

(Comparative)

A PE-coated paper base material which has been provided with an adhesive layer is extrusion-coated in a known manner with a 12.5% strength application solution to provide a layer 14.5 μm in thickness having the following composition:

| | |
|---|---|
| 50% by weight - | of silica dispersion, pigment 3 |
| 20% by weight - | of tetraethylene glycol |
| 8% by weight - | of butadiene-styrene dispersion |
| 10% by weight - | of polyvinylpyrrolidone K 90 |
| 12% by weight - | of polymeric fixative, polymer 7 |

The layer is dried and printed with an Epson Stylus Color 850 inkjet printer. The following color densities are obtained:

| | |
|---|---|
| yellow: | 1.6 |
| magenta: | 2.0 |
| cyan: | 2.4 |
| black: | 2.2 |

The material is water-resistant, but very tacky in the printed areas. After a contact time of 30 seconds with distilled water, noticeable bleeding of the dyes is observed.

After the material has been stored for 3 months, aging of the layer provides a significantly worse ink absorption.

### Example 5

A PE-coated paper base material which has been provided with an adhesive layer is coated similarly to Example 4 with a 13% strength application solution to provide a layer 16 μm in thickness having the following composition:

| | |
|---|---|
| 51% by weight - | of pigment 1 |
| 18.3% by weight - | of tetraethylene glycol |
| 8.2% by weight - | of butadiene-styrene dispersion |
| 14.3% by weight - | of water-soluble ink fixative, polymer 8 |
| 8.2% by weight - | of water-insoluble ink fixative, polymer 12. |

The layer is dried and printed with the following types of printers:

| Color density | HP 2000 C | Epson Stylus Color 850 |
|---|---|---|
| Yellow | 1.9 | 1.8 |
| Magenta | 1.3 | 2.05 |
| Cyan | 1.9 | 2.5 |
| Black | 1.8 | 2.4 |

The material is suitable for both types of printers. The printed areas are nontacky. Contacting with distilled water for 30 seconds does not cause bleeding or color fringing. The values obtained are reproducible even after 3 months of storage.

### Example 6

Example 4 is repeated with a 13.4% strength makeup solution to produce a layer 14 μm in thickness having the following composition:

| | |
|---|---|
| 62% by weight - | of pigment 2 |
| 18% by weight - | of tetraethylene glycol |
| 6% by weight - | of polyethyl acrylate dispersion |
| 14% by weight - | of water-soluble ink fixative, polymer 3 |
| 10% by weight - | of water-insoluble ink fixative, polymer 11 |

The layer is dried and printed with an HP 2000 C printer. The following color densities are obtained:

| | |
|---|---|
| yellow: | 1.6 |
| magenta: | 1.45 |
| cyan: | 1.65 |
| black: | 1.75 |

The layer is water-resistant and does not bleed on contact with water. The printed areas are not tacky and do not show cracks.

### Example 7

Example 4 is repeated with a 12.8% strength makeup solution to produce a layer 16.5 μm in thickness having the following composition:

| | |
|---|---|
| 55% by weight - | of pigment 1 |
| 15% by weight - | of tetraethylene glycol |
| 5% by weight - | of polyethylene oxide 2000 |
| 14.5% by weight - | of water-soluble ink fixative, polymer 7 |
| 10.5% by weight - | of water-insoluble ink fixative, polymer 9 |

The matt layer obtained on drying is provided with a protective layer 3 μm in thickness having the following composition:

| | |
|---|---|
| 80% by weight - | of alkali-digested gelatin |
| 15% by weight - | of butadiene-styrene dispersion |
| 5% by weight - | of curing agent (dimethylcarbamoy |
| | pyridineethanesulfonic acid). |

A water-resistant material having a glossy surface is obtained. The following color densities are obtained on printing with an Epson Stylus Color 850 printer:

| | |
|---|---|
| yellow: | 1.5 |
| magenta: | 1.9 |
| cyan: | 1.75 |
| black: | 1.9 |

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A pigmented recording material comprising an ink-receiving layer, wherein said ink-receiving layer includes the following constituents:
a) 5-25% by weight of polymeric ink-fixing mixture of water-soluble and water-insoluble cationic polymers;
b) 5-20% by weight of a water-soluble plasticizer; and
c) 30-80% by weight of silica dispersion obtained by surface modification with alkylsilanes of the structural formula R₁Si(OR₂)₃ wherein R₁ is vinyl, acryloyl, methacryloyl or C₁-C₈-alkyl, R₂ is methyl or ethyl, and said silica dispersion to said alkylsilane being in a weight ratio in a range from 1:1 to 9:1.

2. The recording material as claimed in claim 1, wherein said ink-receiving layer further includes up to 20% by weight of a polymer dispersion having a glass transition temperature of <25° C.

3. The recording material as claimed in claim 1, wherein said silica dispersion has a particle size in a range from 0.04 to 0.3 μm.

4. The recording material as claimed in claim 1, wherein said ink-receiving layer includes a mixture of silica dispersions having different particle sizes.

5. The recording material as claimed in claim 3, wherein said ink-receiving layer includes a mixture of silica dispersions having different particle sizes.

6. The recording material as claimed in claim 1, wherein said surface modification is effected using an alkylsilane mixture.

7. The recording material as claimed in claim 1, wherein said water-soluble plasticizer is polyethylene glycol having an average molecular weight of from 200 to 20,000 daltons or mixtures thereof.

8. The recording material as claimed in claim 2, wherein said polymer dispersion includes polyacrylates or butanediene-styrene copolymers.

9. The recording material as claimed in claim 1, comprising a layer of at least one crosslinked water-soluble polymer 0.5-5 μm in thickness as protective layer for said ink-receiving layer.

10. The recording material as claimed in claim 2, wherein said silica dispersion has a particle size in a range from 0.04 to 0.3 μm.

11. The recording material as claimed in claim 2, wherein said ink-receiving layer includes a mixture of silica dispersions having different particle sizes.

12. The recording material as claimed in claim 10, wherein said ink-receiving layer includes a mixture of silica dispersions having different particle sizes.

13. The recording material as claimed in claim 2, wherein said surface modification is effected using an alkylsilane mixture.

14. The recording material as claimed in claim 2, wherein said water-soluble plasticizer is polyethylene glycol having an average molecular weight of from 200 to 20,000 daltons or mixtures thereof.

15. The recording material as claimed in claim 2, comprising a layer of at least one crosslinked water-soluble polymer 0.5-5 μm in thickness as protective layer for said ink-receiving layer.

16. A method of printing comprising printing onto the recording material recited in claim 1 using an inkjet printer.

17. A method of printing comprising printing onto the recording material recited in claim 2 using an inkjet printer.

18. A method of printing comprising printing onto the recording material recited in claim 3 using an inkjet printer.

19. A method of printing comprising printing onto the recording material recited in claim 7 using an inkjet printer.

20. A method of printing comprising printing onto the recording material recited in claim 11 using an inkjet printer.

21. A method of forming a pigmented recording material comprising an ink-receiving layer, comprising applying as the ink-receiving layer the following constituents:
a) 5-25% by weight of polymeric ink-fixing mixture of water-soluble and water-insoluble cationic polymers;
b) 5-20% by weight of a water-soluble plasticizer; and
c) 30-80% by weight of silica dispersion obtained by surface modification with alkylsilanes of the structural formula R₁Si(OR₂)₃ wherein R₁ is vinyl, acryloyl, methacryloyl or C₁-C₈-alkyl, R₂ is methyl or ethyl, and said silica dispersion to said alkylsilane being in a weight ratio in a range from 1:1 to 9:1.

22. The recording material as claimed in claim 1, wherein said ink-receiving layer further includes up to 20% by weight of a polymer dispersion having a glass transition temperature of <25° C.
